(19) United States
(12) Patent Application Publication
(10) Pub. No.: US 2007/0220602 A1
(43) Pub. Date: Sep. 20, 2007

(54) Methods and Systems for Comprehensive Management of Internet and Computer Network Security Threats

(76) Inventors: Ray Ricks, Park City, UT (US); Wayne Varga, South Jordan, UT (US)

Correspondence Address: KIRTON AND MCCONKIE, 60 EAST SOUTH TEMPLE,, SUITE 1800, SALT LAKE CITY, UT, 84111, US

(21) Appl. No.: 11/616,383

(22) Filed: Dec. 27, 2006

Related U.S. Application Data
(60) Provisional application No. 60/757,186, filed on Jan. 6, 2006.

(51) Int. Cl. G06F 12/14

(52) U.S. Cl. 726/22

(57) ABSTRACT

The invention relates to systems and methods for management of internet and computer network security threats comprising: a centralized monitoring service; a security management center, wherein the security management center is engineered with rule based and non-linear adaptive analytics to provide intrusion detection, automated response to intrusion attempts, virus detection scanner, spyware scanner, a virtual private network engine, network vulnerability scanner, network activity logger, content filter, SPAM prevention, email activity log and filter, and TBD threat vectors; a remote client; and a hardware device located at the client, wherein the hardware self boots and automatically initiates a virtual private network session with the hosted monitoring and management center after connection to the internet and electrical power.

### RELATED APPLICATION

This application claims priority to U.S. Provisional Application No. 60/757,186 filed Jan. 6, 2006 and entitled “Methods and Systems for Comprehensive Management of Internet and Computer Network Security Threats.”

### FIELD OF THE INVENTION

The invention relates to Methods and Systems for Comprehensive Management of Internet and Computer Network Security Threats. In particular the invention relates to a modular managed security system, which combines various tools for reducing the threats associated with an open network into a single integrated solution.

### BACKGROUND

Network security management is becoming a more difficult problem as networks grow in size and become a more integral part of organizational operations. Computer network attacks can take many forms and any one attack may include many security events of different types including stealing confidential or private information; producing network damage through mechanisms such as viruses, worms, or Trojan horses; and overwhelming the network's capability in order to cause denial of service.

Parallel with the growth of the Internet and its functionality has been the growth of threats to attack user computers, networks and communications. With the projected growth of mobile wireless devices and networks that connect these devices to the internet for services we will also experience similar growth of attacks directed at these devices and their communications.

Current technology for detection and response to Internet threats are deployed as a series of point products such as virus scanners, Spyware scanners and intrusion detection systems. Essentially, they are disparate products that are not interoperable and lacking intelligence sharing between products or solutions. Accordingly, there is a need for improving the interoperability and intelligence sharing between products and solutions of the prior art.

### BRIEF SUMMARY

The invention relates to Methods and Systems for Comprehensive Management of Internet and Computer Network Security Threats. In particular the invention relates to a modular “All-in-One” managed security system which combines various tools for reducing the threats associated with an open network into a single integrated solution. In some embodiments, the invention through a single appliance, or group of appliances for larger installations, most necessary protection, detection, and response efforts can be centralized.

In some embodiments the system is comprised of a hardware appliance and associated software. In some embodiments open source, proprietary and 3^{rd} party software resides on the appliance as well as in the centralized hosted monitoring service and security management center.

In some embodiments for installation the hardware appliance need only be connected to the Internet and electrical power applied. Once these two steps occur, on the client end, the appliance begins self-booting and performs an auto detect and install process. The auto detect determines whether the IP address is dynamic or static and configures according to which it detects. The install automatically initiates a VPN session with the hosted monitoring and management center.

In some embodiments after the VPN is established the appliance begins a download of the system as well as current security file updates and threat signatures. The pre-configured firewall and associated security policies/rules are henceforth established. In some embodiments those rules are subject later to change by the user through the graphical user interface (GUI). In some embodiments a result of the installation process is the establishment of an “All-in-One”, “Plug & Play” managed security system complete with hardware firewall and IPSec VPN router, which requires no previous technical knowledge or Internet security expertise by the user.

In some embodiments configuration of the firewall and services may be direct for those advanced users who know exactly what they want, or others may be guided by a Web based wizard within the GUI application. In some embodiments the wizard asks simple questions and takes the answers to create the ultimate configuration settings. Configuration settings may be stored centrally to prevent loss of information in the event of system failure.

In some embodiments the hardware appliance functionally performs as a security technology platform to guard a computer or network against Internet or network security threats. In some embodiments, the security technology platform has memory mechanisms, within the operating system and applications that can be instantaneously added to or modified.

In some embodiments the managed security system reduces the complexity of setting up, managing and monitoring all of the unique elements required to effectively secure a company. In some embodiments a graphical user interface is utilized to mange the system and provide reports. In some embodiments the various components are combined such that the output of one module may be the input of another.

In some embodiments individual modular components are each designed to address a particular type of threat or a group of threats. In some embodiments as new threats are discovered, new modules may be created or existing one modified to address these threats.

In some embodiments the central monitoring hosted service will connect to the hardware appliance and initiate a download of current or updated code and/or security signatures to threat vectors (Internet threats) as needed.

These and other features and advantages of the invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1: Illustrates an Example of an Overview of the Comprehensive Management of Internet and Computer Security Threats;

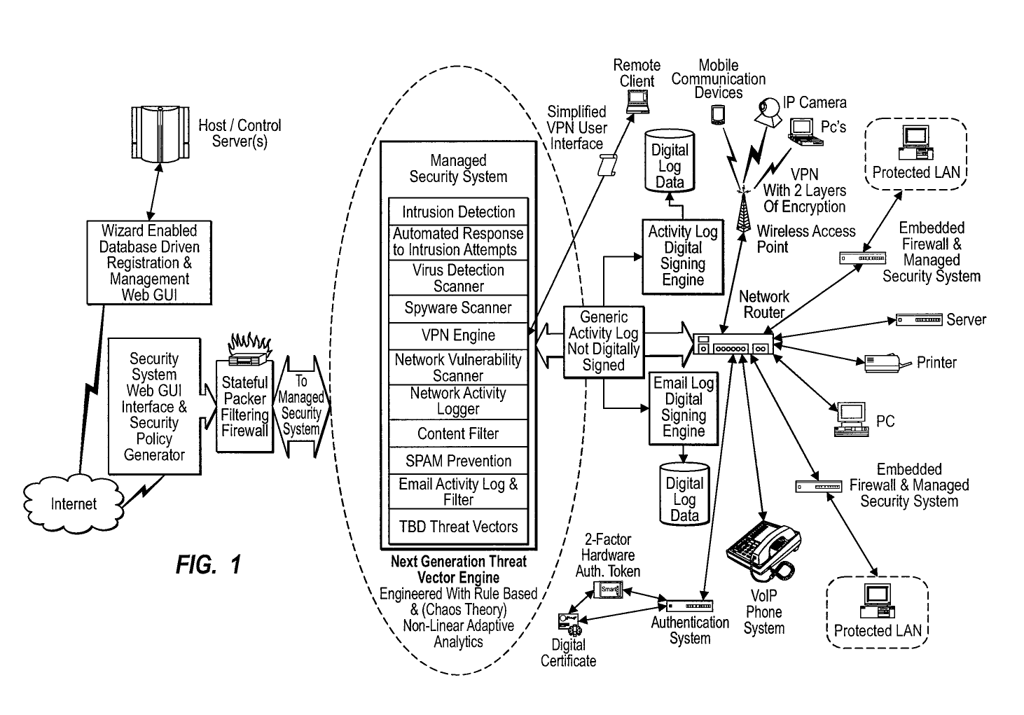

FIG. 2: Illustrates an Example of an Internet Based Technology Platform for a Unified Threat, Managed Security System;

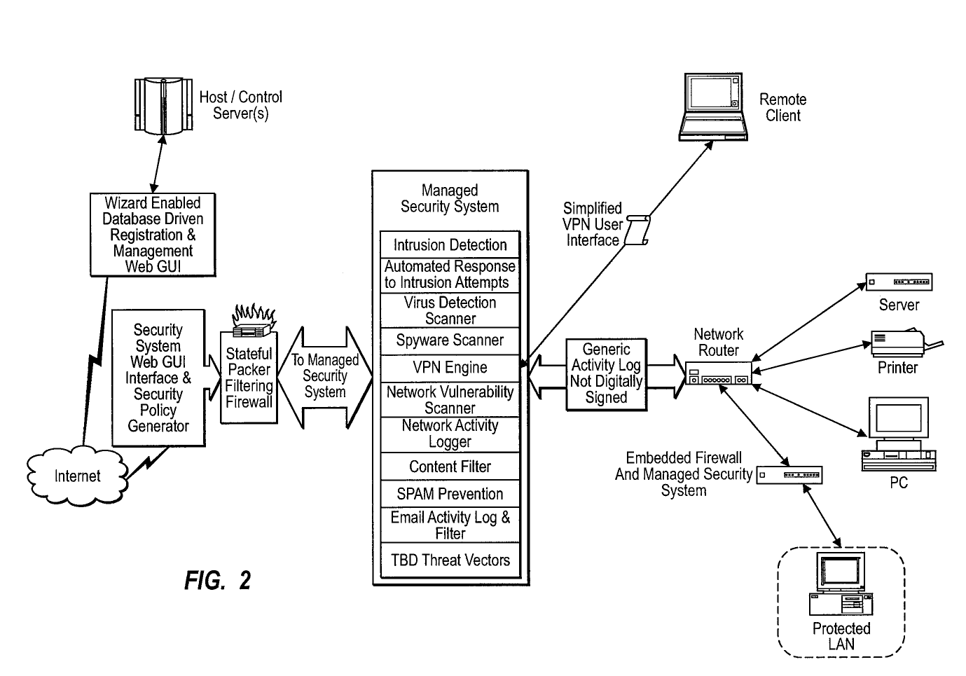

FIG. 3: Illustrates an Example of a Web Based, Wizard Enabled, Database Agnostic Graphical User Interface;

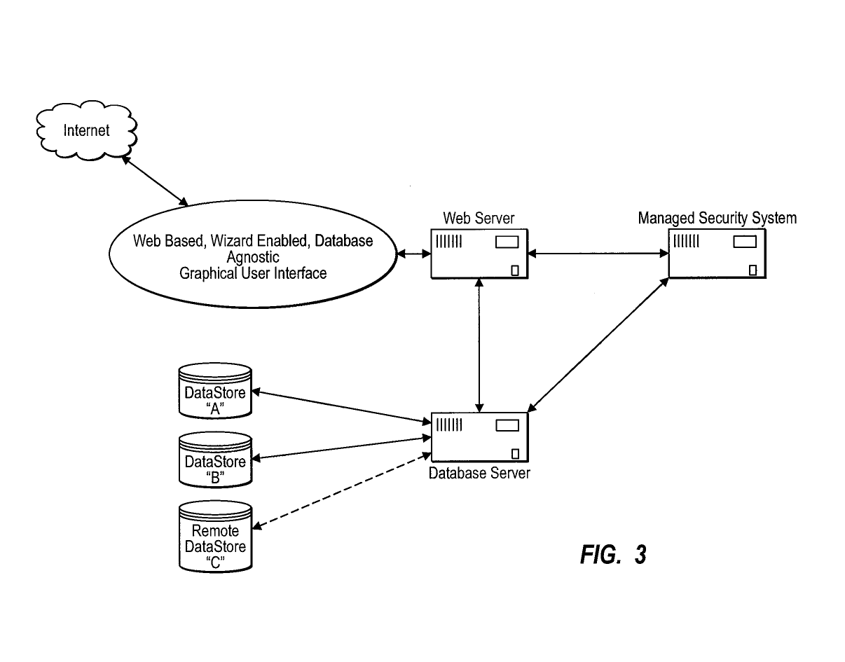

FIG. 4: Illustrates an Example of a VPN Engine;

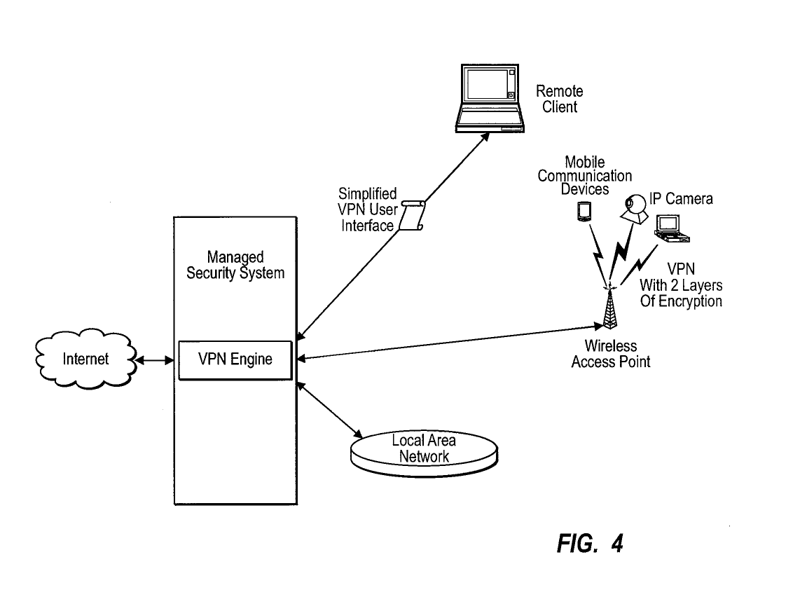

FIG. 5: Illustrates an Example of a Threat Vector Detection & Response Engine;

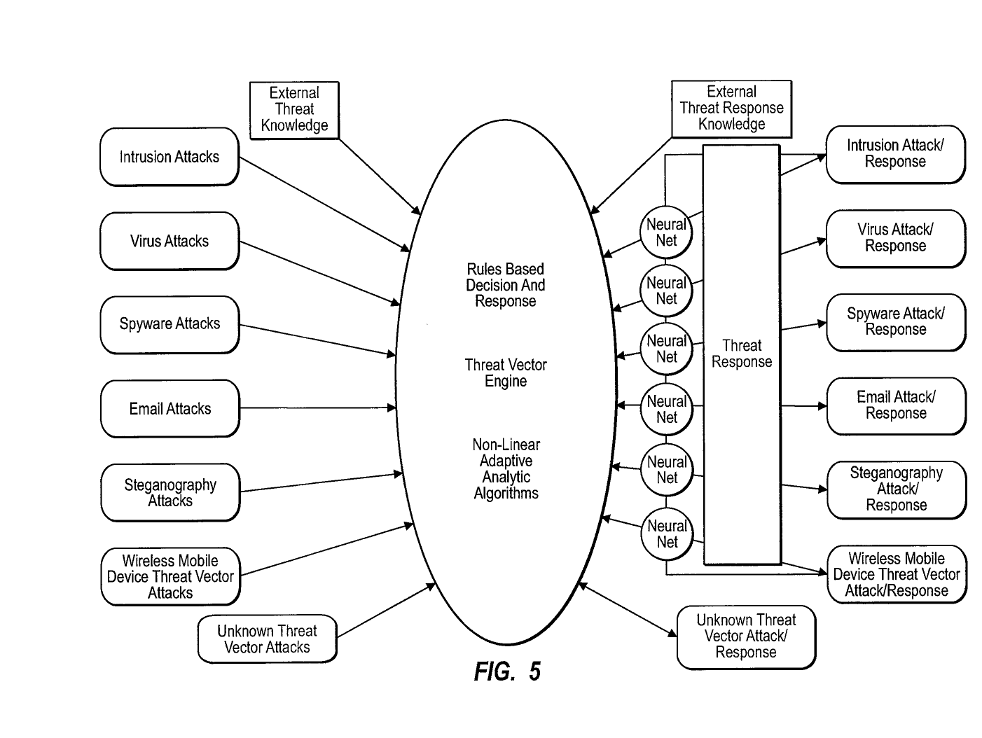

FIG. 6: Illustrates an Example of a Digital Signing System;

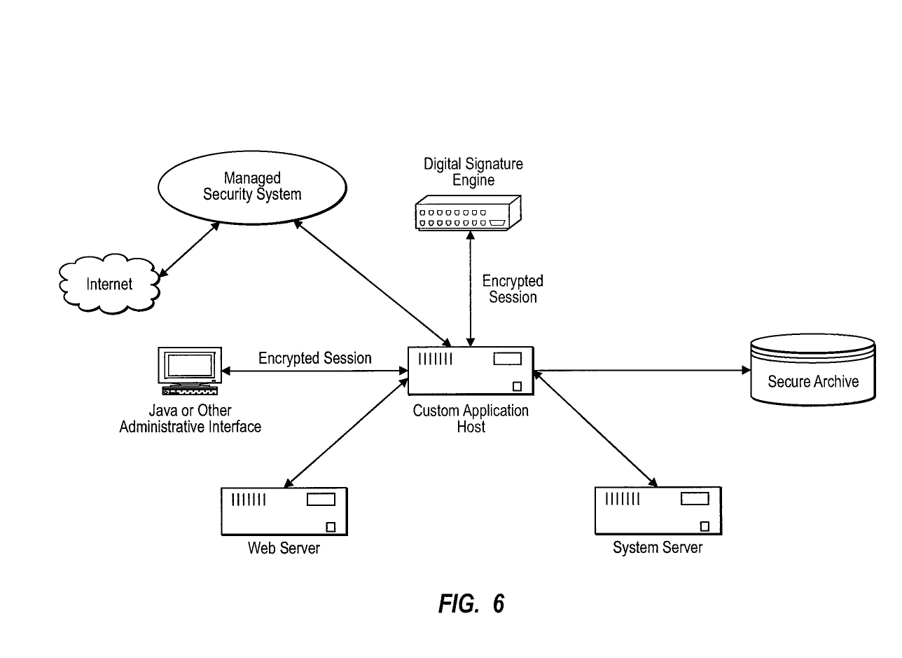

FIG. 7: Illustrates an Example of a Multi-Factor, Two-way, Digital Authentication System; and

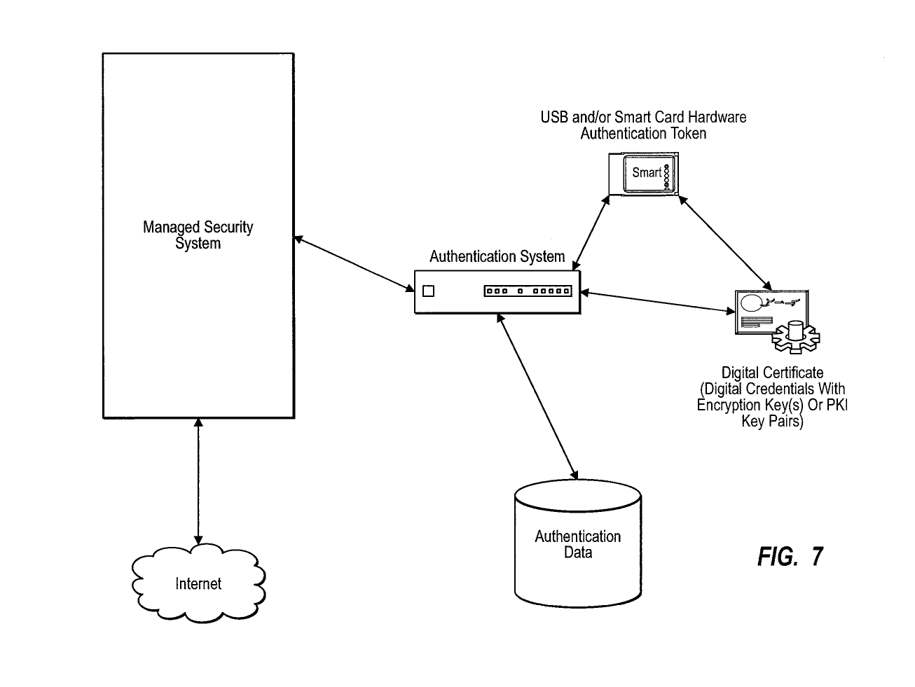

FIG. 8: Illustrates an Example of a Distributed Management of Email and Internet Security Threats to Mobile Wireless Devices with Privacy & Payment Application(s).

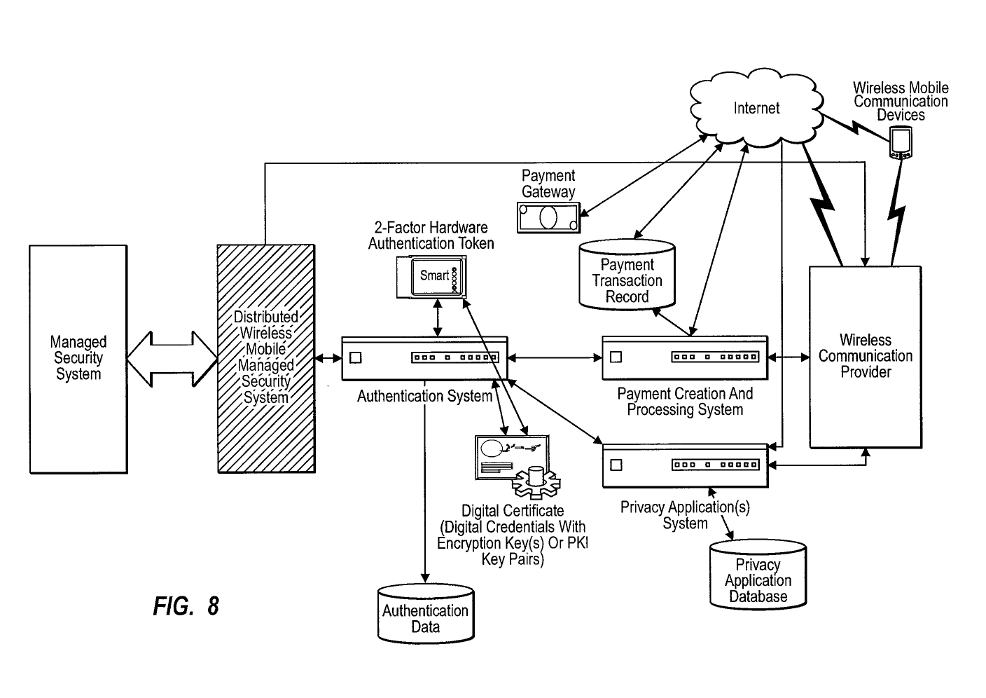

### DETAILED DESCRIPTION OF EXEMPLARY EMBODIMENTS

This specification describes exemplary embodiments and applications of the invention. The invention, however, is not limited to these exemplary embodiments and applications or to the manner in which the exemplary logical embodiments and applications operate or are described herein. It will be readily understood that the components of the present invention, as generally described herein, could be arranged and designed in a wide variety of different configurations. Thus, the following more detailed description of embodiments of the compositions and methods of the present invention is not intended to limit the scope of the invention, as claimed, but is merely representative of the presently preferred embodiments of the invention. The scope of the invention is, therefore, indicated by the appended claims rather than by the foregoing description. All changes that come within the meaning and range of equivalency of the claims are to be embraced within their scope.

It will be appreciated by those of ordinary skill in the art that the objects of this invention can be achieved without the expense of undue experimentation using well known variants, modifications, or equivalents of the methods and techniques described herein. The skilled artisan will also appreciate that alternative means, other than those specifically described, are available in the art to achieve the functional features of the molecules described herein. It is intended that the present invention include those variants, modifications, alternatives, and equivalents which are appreciated by the skilled artisan and encompassed by the spirit and scope of the present disclosure.

The invention relates to Methods and Systems for Comprehensive Management of Internet and Computer Network Security Threats. In particular the invention relates to a modular “All-in-One” Unified Theat, managed security system, which combines various tools for reducing the threats associated with an open network into a single integrated solution. In some embodiments, the invention through a single appliance, or group of appliances for larger installations, most necessary protection, detection, and response efforts can be centralized.

In some embodiments the system is comprised of a hardware appliance and associated software. In some embodiments open source, proprietary and 3^{rd} party software resides on the appliance as well as in the centralized hosted monitoring service and security management center.

In some embodiments for installation the hardware appliance need only be connected to the Internet and electrical power applied. Once these two steps occur, on the client end, the appliance begins a self-booting and performs an auto detect and install process. The auto detect determines whether the IP address is dynamic or static and configures according to which it detects. The install automatically initiates a VPN session with the hosted monitoring and management center.

In some embodiments after the VPN is established the appliance begins a download of the system as well as current security file updates and threat signatures. The pre-configured firewall and associated security policies/rules are henceforth established. In some embodiments those rules are subject later to change by the user through the graphical user interface (GUI). In some embodiments a result of the installation process is the establishment of an “All-in-One”, “Plug & Play” Unified Threat, managed security system complete with hardware firewall and VPN router, which requires no previous technical knowledge or Internet security expertise by the user.

In some embodiments configuration of the firewall and services may be direct for those advanced users who know exactly what they want, or others may be guided by a Web based wizard within the GUI application. In some embodiments the wizard asks simple questions and takes the answers to create the ultimate configuration settings. Configuration settings may be stored centrally to prevent loss of information in the event of system failure.

In some embodiments the hardware appliance functionally performs as a security technology platform to guard a computer or network against Internet or network security threats. In some embodiments, the security technology platform has memory mechanisms, within the operating system and applications that can be instantaneously added to or modified.

In some embodiments the managed security system reduces the complexity of setting up, managing and monitoring all of the unique elements required to effectively secure a company. In some embodiments a graphical user interface is utilized to mange the system and provide reports. In some embodiments the various components are combined such that the output of one module may be the input of another.

In some embodiments individual modular components are each designed to address a particular type of threat or a group of threats. In some embodiments as new threats are discovered, new modules may be created or existing one modified to address these threats.

In some embodiments the central monitoring hosted service will connect to the hardware appliance and initiate a download of current or updated code and/or security signatures to threat vectors (Internet threats) as needed.

These and other features and advantages of the invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

The following disclosure of the present invention is grouped into subheadings. The utilization of the subheadings is for convenience of the reader only and is not to be construed as limiting in any sense.

1. Internet Based Technology Platform for the Unified Threat, Managed Security System

The invention relates to Methods and Systems for Comprehensive Management of Internet and Computer Network Security Threats. In particular the invention relates to a modular “All-in-One” Unified Threat, managed security system, which combines various tools for reducing the threats associated with an open network into a single integrated solution. In some embodiments, the invention through a single appliance or group of appliances for larger installations, most necessary protection, detection, and response efforts can be centralized. For this embodiment centralized means that certain protective functions are performed on the Host/Control Server from a remote location. As designed, communication and files are sent by the hardware appliance to the Host/Control Server. This data is analyzed using a portion of the Threat Vector Engine. Based on that analysis, changes in policy may be pushed down to the hardware appliance where they will be integrated into the currently implemented protections.

In some embodiments the system is comprised of a hardware appliance and associated software. In some embodiments open source, proprietary and 3^{rd} party software resides on the appliance as well as in the centralized hosted monitoring service and security management center.

In some embodiments for installation the hardware appliance need only be connected to the Internet and electrical power applied. Once these two steps occur, on the client end, the appliance begins a self-booting and performs an auto detect and install process. The auto detect determines whether the IP address is dynamic or static and configures according to which it detects. The install automatically initiates a VPN session with the hosted monitoring and management center.

In some embodiments after the VPN is established the appliance begins a download of the system as well as current security file updates and threat signatures. The pre-configured firewall and associated security policies/rules are henceforth established. In some embodiments those rules are subject later to change by the user through the graphical user interface (GUI). In some embodiments a result of the installation process is the establishment of an “All-in-One”, “Plug & Play” Unified Threat, managed security system complete with hardware firewall and VPN router, which requires no previous technical knowledge or Internet security expertise by the user. All the functionality of the Unified Threat, managed security system maybe implemented in a single device or spread across multiple appliances depending on the size, scale and scope of the implementation.

In some embodiments configuration of the firewall and services may be direct for those advanced users who know exactly what they want, or others may be guided by a Web based wizard within the GUI application. In some embodiments the wizard asks simple questions and takes the answers to create the ultimate configuration settings. Configuration settings may be stored centrally to prevent loss of information in the event of system failure.

In some embodiments the hardware appliance functionally performs as a security technology platform to guard a computer or network against Internet or network security threats. In some embodiments, the security technology platform has memory mechanisms, within the operating system and applications that can be instantaneously added to or modified.

In some embodiments the managed security system reduces the complexity of setting up, managing and monitoring all of the unique elements required to effectively secure a company. In some embodiments a graphical user interface is utilized to mange the system and provide reports. In some embodiments the various components are combined such that the output of one module may be the input of another.

In some embodiments individual modular components are each designed to address a particular type of threat or a group of threats. In some embodiments as new threats are discovered, new modules may be created or existing one modified to address these threats.

In some embodiments the central monitoring hosted service will connect to the hardware appliance and initiate a download of current or updated code and/or security signatures to threat vectors (Internet threats) as needed, and at least once per day in preferred embodiments.

2. Web Based, Wizard Enabled, Database Agnostic Graphical User Interface

Some embodiments comprise a Web based, wizard enabled, database agnostic software development engine with a graphical user interface. Database agnostic refers to the embodiments capability to interoperate with any type of data store. Accordingly, some embodiments allow non-technical staff to develop Web or HTML applications simply by answering elementry questions about the structure of the application and the flow of the questions. The embodiment will take the answers to these questions and create the functional applications. These applications can create and interface with databases wherever they reside. Some embodiments comprise a wizard or agent that can appear in each data field prompting additional queries or presenting additional information. The voice or text associated with the wizard may be changed at will from a text file within a database. Accordingly, some embodiments reduce or eliminate the need for a database application programmer and database administrator, reducing the cost of database development and time to completion of database applications.

3. VPN Engine

Some embodiments include a Virtual Private Network (“VPN”). The VPN engine may comprise various methods for establishing a VPN connection. In preferred embodiments the VPN engine utilizes current industry standard VPN protocols. These protocols include but are not limited to IPSec, Point-to-Point Tunneling, SSL and L2TP. In preferred embodiments each of these public technologies establishes an authenticated and trusted connection resulting in an encrypted communication session.

Some embodiments use these VPN technologies in a method and system with a simple user interface that permits a novice computer user to establish a remote VPN client in a matter of a few minutes.

Some embodiments of the VPN Engine also extend to proprietary private and confidential wireless networks as an encryption wrapper to standard wireless encryption(s). The result is two factor or layered encryption tunnels, or tunnel within a tunnel. Preferred embodiments of the technology can authenticate and encrypt communications between any Internet protocol (IP) device, to include but not limited to Web cameras, mobile wireless devices, personal computers and servers.

4. Threat Vector Detection & Response Engine

Current technology for detection and response to Internet threats is a series of point products such as virus scanners, Spyware scanners and intrusion detection systems. Essentially, they are disparate products that are not interoperable and lacking intelligence sharing between products or solutions.

Accordingly, preferred embodiments of the invention comprise a single Threat Vector Engine that will singularly detect and respond to all threats current and future, which today are not foreseeable. Threats include but are not limited to intruders or hackers, viruses, Spyware, Internet predators, and content threats such as inappropriate communication, threatening language, bullying, and pornography. Threats today can be received through legitimate communication applications such as streaming audio, streaming video, email, Instant Messaging and Chat, RSS (Really Simple Syndication, Rich Site Summary or RDF Site Summary) and PICS (Platform for Internet Content Selection) a specification which enables labels (metadata) to be associated with Internet content but, it also facilitates other uses for labels, including code signing and privacy. The PICS platform is one on which other rating services and filtering software have been built.

In preferred embodiments the Threat Vector Engine will be trainable, create knowledge, retain knowledge and have a predictive quality that permits varieties of responses to be taken including but not limited to re-direction, forensics collection, registration of threat, data storage, filtering and blocking and/or masking of all or parts of an Internet communication, reply messaging which may include warnings, and termination of the IP connection. In preferred embodiments the synergistic effect of the threat detection and response engine will allow integrated parts or modules to share threat vectors thus becoming a larger more intelligent embodiment.

In preferred embodiments the Threat Vector Engine will embody threats directed at a variety of targets including all Internet connections, Internet user's and Internet devices comprising computing devices such as servers, personal computers, wireless cameras and mobile wireless devices such as personal digital assistants (PDA's) and cellular communications, wide area wireless networks (hot spots), IP telephony and localized wireless networks.

In preferred embodiments the technology employed will embody linear rules (if, and type statements) and/or non-linear analytical, and/or algorithmic technologies used in understanding and describing neural networks and chaos theory.

Acquired knowledge as well as developed knowledge from the analysis performed, in this embodiment, will be archived in data stores for forensic purposes, future analysis, reporting and data discovery.

5. Digital Signing System

Some embodiments may further comprise an application server, a Digital Signing Engine, a Secure Archive, a Java-based administrative interface, and a network or Web server that passes the files to be encrypted and/or signed to the application host. In some embodiments the custom application host manages the data from the network or Web server by preparing it for signing and archiving. In preferred embodiments, in addition to performing the custom application functions, the system may also apply Hash technology, which makes it possible to tell whether an individual data entry has been modified without compromising the integrity of the entire archive file. In preferred embodiments the signing engine is a hardware-accelerated, secure cryptographic network appliance that adds reliable GPS time and location data to each log entry, and then digitally signs the log entry using private keys securely contained within the embedded hardware appliance. Because in preferred embodiments the Digital Signer module is a hardware-based offline network appliance, it is both extremely secure and fast—the Digital Signer engine will be able to process 1,000 or more cryptographic functions per second. Accordingly, in preferred embodiments the processing capacity allows additional modules, such as the Secure Log Server, Secure Email Archive, Secure Web Host, Secure Digital Media Server, and the Secure Web Services System to be added to the system as needed.

In some embodiments the Secure Archive is a CD-R or DVD-R or other similar media that has been adapted to serve as a WORM device. Technology is used to facilitate real-time archiving of the log events bit-by-bit onto optical media. This allows for cost effective storage with the security of traditional WORM devices. In preferred embodiments the Java-based administrative interface facilitates system monitoring, system configuration changes, and manual data searches and validations. In preferred embodiments the interface also allows a non-technical business professional to easily monitor system activity, as well as automatically receive notifications about system events and alerts.

In some embodiments when a new data record is generated, the reporting agent is authenticated by the custom application host, a secure communications link is established, and the new data record is then transmitted to the custom application host. In preferred embodiments the application host processes the data, applies a Hash technology to the data record, and then passes the data record to the Digital Signer engine. In preferred embodiments the Digital Signer engine adds reliable GPS time and location elements to the data record and then digitally signs and/or encrypts the entry. After performing the cryptographic function, the Digital Signer may pass information back to the custom application host, which can then perform other custom application processes in addition to sending the signed and/or encrypted record to the Secure Archive.

In preferred embodiments the Data's Digital Signer Secure Data Engine increases the security of a customer's network by preventing data records from being modified or deleted, and in turn, deters fraudulent or malicious activity.

In some embodiments the engine enables a customer to implement a cost-effective custom data security solution based on various available technologies and dramatically reduces administrative costs associated with maintaining a high-value network, allows a system administrator to make changes to the network without a witness (effectively a dual control), and if hosted remotely, further reduces the work load placed on an organization's IT department. In some embodiments the Java-based administration tool may run unmodified on Solaris®, Linux®, and/or Windows® platforms. In preferred embodiments non-technical business professionals may monitor and be alerted to potential breaches in security. And, if needed, the administrative tool can also be customized to perform additional network management functions.

Some embodiments further comprise a Digital Signer Secure Data Engine which produces, forensically viable data that may be used to: 1) validate internal disciplinary actions; 2) to prosecute or defend a legal claim in a court of law (because data contained within the Digital Signer Secure Data Engine cannot be tampered with, Digital Signer significantly reduces the risk of having the data dismissed due to the inadmissibility of evidence); and/or 3) establishes a deterrent for misuse, destruction or theft of system data and/or resources by IT administrators or other employees of an organization.

6. Multi-Factor Digital Authentication System

In some embodiments the authentication system acts as a central place to verify the identity and access rights of individuals on the wired or wireless network. In preferred embodiments the authentication system may store UserID and password combinations. Some embodiments may further comprise additional authentication methods which may be part of or separate from elements such as biometric, security physical tokens, including but not limited to USB Flash devices, smart cards, optical media, digital certificates or combination of these technologies. In preferred embodiments all devices and systems on the network may use the services offered by the authentication system, which may be positioned internal or external to the managed security system and hardware appliance, to verify the identity of users and to determine the access rights and/or permissions that have been granted to the user. This authentication system may also involve one or more encryption technologies to include a combination of encryption methodologies, to protect the secrecy of the authentication keys and/or data.

7. Distributed Management of E-mail and Internet Security Threats to Mobile Wireless Devices with Secured Payment and Privacy Application(s)

Some embodiments of the distributed security platform for mobile wireless communication devices may be used to protect privacy, secure wireless transactions and prevent identity theft. Preferred embodiments utilized strong device authentication to a trusted authentication network. Some embodiments may utilize process calls for mobile authentication to/from digital credentials embedded in form factors, which may include for example, USB tokens, SIMM cards, smart cards, “one time key pads” and Web browsers.

Some embodiments of a payment system for the mobile wireless systems may comprise a user requesting a device to make a payment accompanied by an authorization. The transaction may then be encrypted and digitally signed with recognized technology, such as but not limited to Public Key Infrastructure (PKI), as a one time only or unique transaction. Some embodiments may further comprise “one time keypad.” In preferred embodiments the authentication system then authenticates the credentials of the user. In preferred embodiments payment is then presented to the screen of the device as a two (2) dimensional bar code. The bar code may then be scanned by the payee with commonly used or industry standard scanning technology. The payment may then be debited from an out of network account or billed directly to an in-network account such as that of the user's mobile wireless device provider.

The privacy application may be integrated with a mobile wireless device. This integration can be with technology provided by the wireless device manufacturer/service provider or with an application loaded to the wireless device in the form of software or in hardware/firmware peripheral such as a SIMM card/chip or other hardware. In some embodiments a pay token device may be utilized. The peripheral may have user credentials and encryption keys present in it. These credentials may be used to authenticate to the distributed security and authentication system.

Some embodiments may allow storage of the users call directory elsewhere in the distributed security system. In preferred embodiments the wireless device may be utilized to call at least daily to the system to upload and archive the user directory.

In some embodiments if the wireless device is lost, stolen or damaged action may be taken. In preferred embodiments two processes may occur. First, if the device is a new or repaired wireless device, then the device and user may be registered to the distributed security network and authentication system. Subsequently, the directory may be uploaded to the new wireless device. Secondly, a signal may then be sent to the previous wireless device that was lost, stolen, damaged. The signal or message is an instruction for the device, on the next connection or attempted connection in an “on” mode, to format the directory, call record and text message history. The result is the privacy of the user and connected parties are protected.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system for management of internet and computer network security threats comprising:
a centralized monitoring service;
a security management center, wherein said security management center comprises a rule based and non-linear adaptive analytics to provide intrusion detection, automated response to intrusion attempts, virus detection scanner, spyware scanner, a virtual private network engine, network vulnerability scanner, network activity logger, content filter, SPAM prevention, email activity log and filter, and TBD threat vectors;
a remote client; and
a hardware device located at the client, wherein the hardware self boots and automatically initiates a virtual private network session with the hosted monitoring and management center after connection to the internet and electrical power.

2. The system of claim 1, wherein security management center further comprises a pre-configured firewall and associated security policies/rules.

3. The system of claim 1, wherein remote client automatically downloads current security file updates and threat signatures.

4. The system of claim 1, further comprising a graphical user interface for changing rules on managed security system or on remote client hardware device.

5. The system of claim 1, wherein the central monitoring hosted service will connect to the hardware appliance and initiate a download of current or updated code and/or security signatures, threat vectors, and Internet threats as needed.

6. The system of claim 1, wherein remote client further comprises wireless access point with a virtual private network and at least two layers of encryption for communication with Mobile devices.

7. A method for management of internet and computer network security threats comprising the steps of:
installing a hardware appliance at a remote location;
connecting hardware appliance to the internet;
connecting the hardware appliance to electrical power;
automatically connecting hardware appliance by a virtual private network to a managed security system and centralized monitoring service; and
managing the security system with a security management, wherein said security management center comprises a rule based and non-linear adaptive analytics to provide intrusion detection, automated response to intrusion attempts, virus detection scanner, spyware scanner, a virtual private network engine, network vulnerability scanner, network activity logger, content filter, SPAM prevention, email activity log and filter, and TBD threat vectors.

8. The method of claim 7, wherein the step of managing the security system further comprises the step of utilizing a pre-configured firewall and associated security policies/rules.

9. The method of claim 7, further comprising the step of automatically downloads current security file updates and threat signatures.

10. The method of claim 7, further comprising a graphical user interface for changing rules on managed security system or on remote client hardware device.

11. The method of claim 7, wherein the central monitoring hosted service will connect to the hardware appliance and initiate a download of current or updated code and/or security signatures, threat vectors, and Internet threats as needed.

12. The method of claim 7, wherein remote client further comprises wireless access point with a virtual private network and at least two layers of encryption for communication with Mobile devices.

13. A computer program product for implementing within a computer system a method for management of internet and computer network security threats, the computer program product comprising:
a computer readable medium for providing computer program code means utilized to implement the method, wherein the computer program code means is comprised of executable code for implementing the steps for:
automatically connecting a hardware appliance located at a remote location by a virtual private network to a managed security system and centralized monitoring service wherein the managed security system is engineered with rule based and non-linear adaptive analytics to provide intrusion detection, automated response to intrusion attempts, virus detection scanner, spyware scanner, a virtual private network engine, network vulnerability scanner, network activity logger, content filter, SPAM prevention, email activity log and filter, and TBD threat vectors; and
automatically downloading security file updates and threat signatures to hardware appliance at remote location from the managed security system.
